(19) United States
(12) Patent Application Publication
(10) Pub. No.: US 2006/0014521 A1
(43) Pub. Date: Jan. 19, 2006

(54) Data protection method and system using the same

(76) Inventors: Zhi-Wen Chen, Shanghai (CN); Shih-Kuang Tsai, Taipei County (TW); Tai-Shui Ho, Taipei (TW)

Correspondence Address: BIRCH STEWART KOLASCH & BIRCH, PO BOX 747, FALLS CHURCH, VA, 22040-0747, US

(21) Appl. No.: 10/890,276

(22) Filed: Jul. 14, 2004

(51) Int. Cl. H04M 1/66

(52) U.S. Cl. 455/410

(57) ABSTRACT

A data protection method. The data protection method is implemented between a server and a mobile communication device capable of wireless communication with the server. The mobile communication device transmits a media download request to the server for downloading of media data. The server receives the media download request and then generates a description file, a protected media file and a license file. The description file comprises download information of the protected media file and the license file. The protected media file comprises a set of encrypted data generated from encrypting the media data. The license file comprises a decryption key for decrypting the encrypted data into the requested media data. The server transmits the description file to the mobile communication device. The mobile communication device receives the description file from the server.

### BACKGROUND

The invention relates to wireless communication techniques, and in particular to a data protection method for protecting media data.

Presently, certain mobile phones are capable of downloading media data through wireless communication from the Internet using Hypertext Transmission Protocol (HTTP) and Wireless Application Protocol (WAP). The downloaded media data is typically plain text. When no protection mechanism is provided, mobile phone users can transfer the downloaded media data to other users via the mobile phone. Occasionally, media data comprising high value content may be copied arbitrarily.

Some media designers establish their own media data formats which are different from standard media formats. To decode and play special format media data, a mobile phone must support the special format. Under this condition, compatibility of shared media data is reduced, reversing the media data format and mobile phone standardization trend.

Hence, a need exists for a data protection method capable of ameliorating the above-described disadvantages of conventional techniques.

### SUMMARY

Accordingly, an object of the invention is to provide a data protection method implemented in a server and a mobile communication device capable of wireless communication with the server. The mobile communication device transmits a media download request to the server for downloading a set of media data. The server receives the media download request and then generates a description file, a protected media file and a license file in response to the media download request. The description file comprises download information of the protected media file and the license file. The protected media file comprises a set of encrypted data generated from encrypting the set of media data. The license file comprises a decryption key for decrypting the encrypted data into media data. The server transmits the description file to the mobile communication device. The mobile communication device receives the description file from the server.

Additionally, the invention provides a data protection method implemented in a server capable of wireless communication with a mobile communication device. The server receives a media download request from the mobile communication device, wherein the media download request requests transmission of media data to the mobile communication device. The server generates a description file, a protected media file and a license file corresponding to the requested. The description file comprises download information of the protected media file and the license file. The protected media file comprises encrypted data generated from the media data. The license file comprises a decryption key for decrypting the encrypted data into unencrypted media data. The server transmits the description file to the mobile communication device.

Additionally, an embodiment of the invention provides a data protection method implemented in a mobile communication device capable of wireless communication with a server. The mobile communication device transmits a media download request to the server for downloading media data. The mobile communication device receives a description file from the server, wherein the description file comprises download information of a protected media file and a license file. The protected media file comprises a set of encrypted data generated by the server encrypting the set of the media data. The license file comprises a decryption key for decrypting the encrypted data into decrypted media data. The mobile communication device transmits a protected media file download request to the server for downloading the protected media file based on the download information of the protected media file. The mobile communication device receives the protected media file from the server. The mobile communication device transmits a license file download request to the server for downloading the license file based on the download information of the license file. The mobile communication device receives the license file from the server.

Additionally, the invention provides a data protection system comprising a mobile communication device and a server. The server is capable of wireless communication with the mobile communication device. The server receives a media download request from the mobile communication device, wherein the media download request is used for requesting transmission of media data to the mobile communication device. The server generates a description file, a protected media file and a license file of the set of media data in response to the media download request. The description file comprises download information of the protected media file and the license file. The protected media file comprises encrypted data generated from encrypting the media data. The license file comprises a decryption key for decrypting the encrypted data into the decrypted media data, and the server transmits the description file to the mobile communication device.

### DESCRIPTION OF THE DRAWINGS

Embodiments of the invention can be more fully understood by reading the subsequent detailed description and examples with references made to the accompanying drawings, wherein:

FIG. 1 is a block diagram of the configuration of a data protection system of an embodiment of the invention;

FIG. 2 is a flowchart of the data protection method of an embodiment of the invention;

FIG. 3 is a schematic diagram of a description file of an embodiment of the invention;

FIG. 4 is a schematic diagram of a protected media file of an embodiment of the invention; and

FIG. 5 is a schematic diagram of a license file of an embodiment of the invention.

### DETAILED DESCRIPTION

An embodiment of the invention provides a data protection method implemented in a data protection system comprising a server and a mobile communication device.

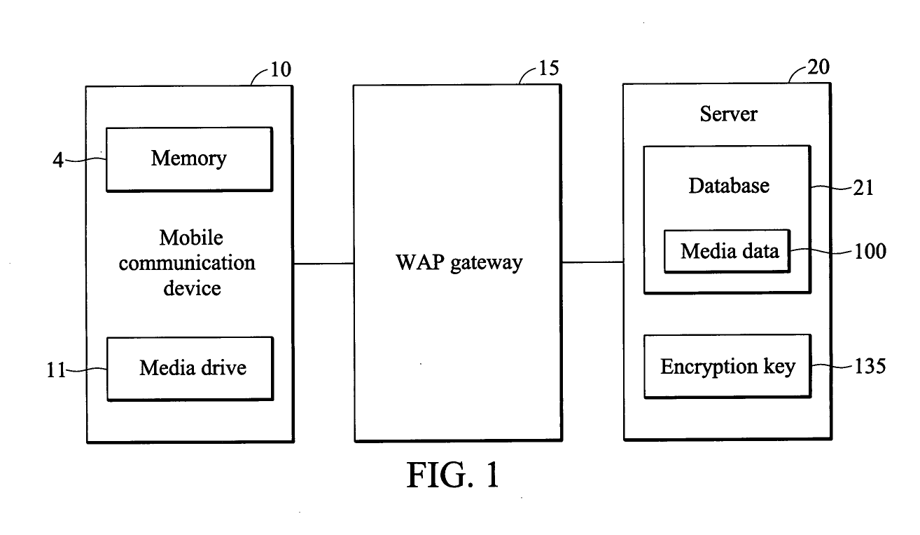

FIG. 1 is a block diagram of the configuration of a data protection system of the invention. The data protection system comprises a mobile communication device 10, WAP gateway 15, and a server 20. Mobile communication device 10 is capable of wireless communication comprising but not limited to decoding and playing media data. Mobile communication device 10 may comprise various mobile communication devices, such as a mobile phone or a person digital assistant (PDA).

Mobile communication device 10 comprises memory 4, a media drive 11 responsible for reading, decoding and playing media data. WAP gateway 15 is a conventional Wireless Application Protocol (WAP) gateway connecting mobile communication device 10 and server 20 is capable of end-user authentication. Server 20 comprises an encryption key 135 and a database 21 storing a plurality of media data comprising media data 100.

Media data 100 may comprise various kinds of media data, such as video game programs, still images, video clips, audio clips, or text. Media data in the description conform to Multipurpose Internet Mail Extensions (MIME) formats. It is noted that the media data is not limited to the mentioned format.

WAP gateway 15 connects to server 20 through the Internet. Mobile communication device 10 may connect to WAP gateway 15 through a wireless telecommunication network.

The data protection method of an embodiment of the invention can be implemented in server 20 and mobile communication device 10. Mobile communication device 10 communicates with server 20 through WAP gateway 15. In other words, all transmission data between mobile communication device 10 and server 20 will be transferred by WAP gateway 15. Thus, a detailed description of the data transfer via WAP gateway 15 is omitted in following. Mobile communication device 10 communicates with server 20 using Wireless Application Protocol (WAP). It is noted that this arrangement is not intended to limit the invention.

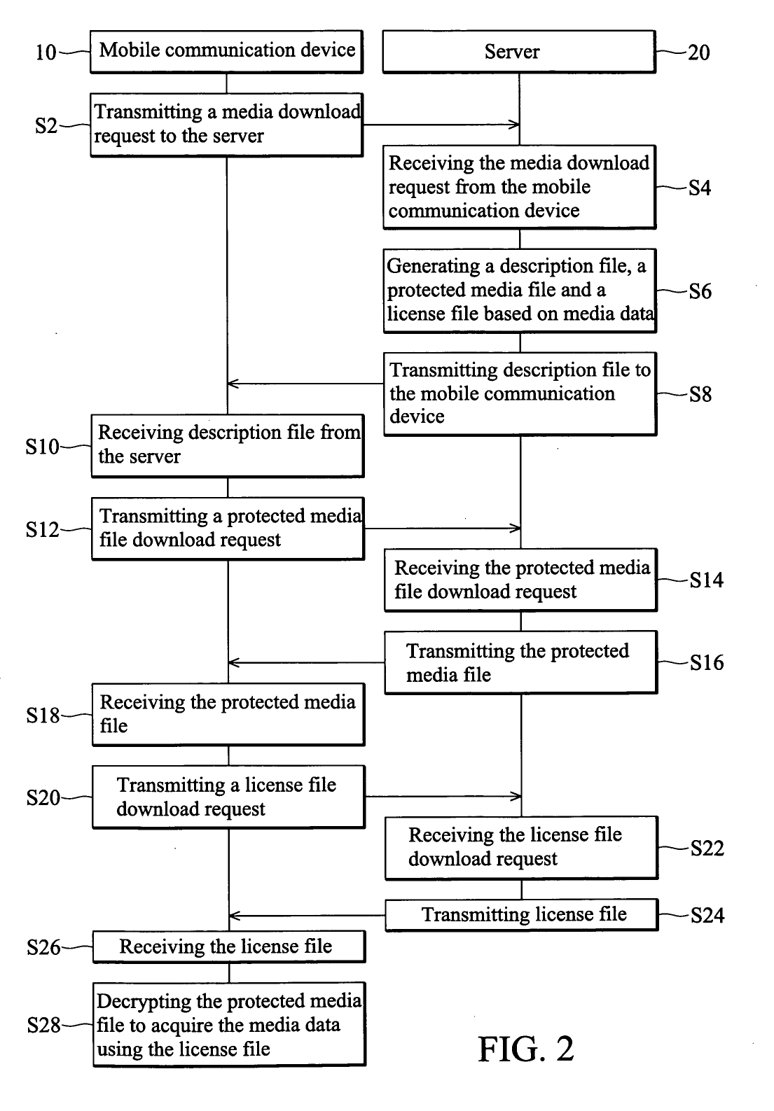

FIG. 2 is a flowchart of the data protection method of the invention.

Mobile communication device 10 transmits a media download request to the server 20 (step S2), wherein the media download request is used for downloading media data 100 from the server 20 to mobile communication device 10.

Server 20 receives the media download request from the mobile communication device (step S4). Server 20 generates a description file 110, a protected media file 120 and a license file 130 based on media data 100 (step S6) in response to the media download request. In an embodiment of the invention, Server 20 generates description file 110, protected media file 120 and license file 130 after receiving the media download request. The arrangement ameliorates heavy workload caused by translating each of media data in database 21 into three kinds of corresponding files in advance as described above. In addition, production license file content may be controlled individually. In other words, the license file content for individual media data may be different. Thus, translating media data in database 21 into three corresponding files in advance generates a heavy work load on the server.

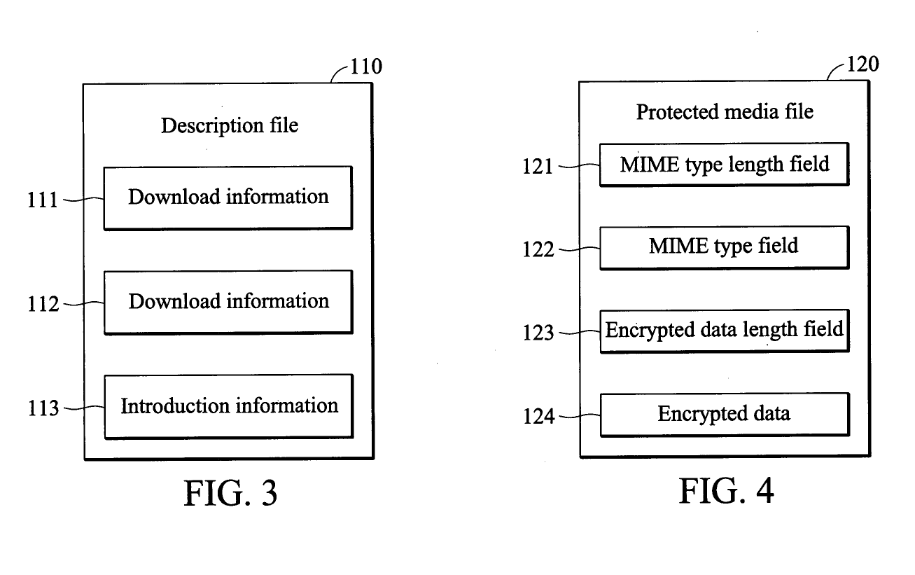

FIG. 3 is a schematic diagram of a description file of an embodiment of the invention. Description file 110 comprises download information 111 for protected media file 120, download information 112 for license file 130 and introduction information 113 of media data 100. Description file 110 may further comprise other information. Download information 111 comprises the address of protected media file 120. Download information 112 comprises the address of license file 130. For example, if server 20 generates and stores protected media file 120 and license file 130 therein, download information 111 and 112 comprises the address of server 20 and further comprises paths of protected media file 120 and license file 130 respectively. It is noted that this arrangement is not intended to limit the invention. Server 20 may couple to other servers, for example, a first server and a second server. If server 20 generates and stores protected media file 120 and license file 130 in the first server and the second server respectively, download information 111 and 112 comprises the addresses of the first and second server respectively rather than the address of server 20.

Introduction information 113 comprises introductory information or description of media data 100. A user of mobile communication device 10 may read the introduction information 113 to determine whether to download protected media file 120 and license file 130.

FIG. 4 is a schematic diagram of a protected media file of the invention. Protected media file 120 comprises a MIME type length field 121, a MIME type field 122, an encrypted data length field 123 and encrypted data 124. All protected media files conform to the same MIME type format regardless of the MIME type of the original media data. The server may encode media data 100 using any encoding method, such as binary encoding or UU-encoding.

MIME type length field 121 records MIME type length. MIME type field 122 records MIME type. Encrypted data length field 123 records the length of the encrypted data 124. Encrypted data 124 is generated from encrypting media data 100 using an encryption key 135 on server 20, i.e. encrypted data 124 comprises encrypted media data 100. It is noted that protected media file 120 may comprise other information.

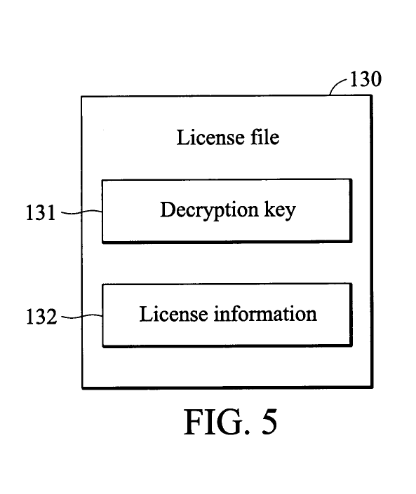

FIG. 5 is a schematic diagram of a license file of the invention. License file 130 comprises a decryption key 131 and license information 132. Decryption key 131 is used for decrypting the encrypted data 124 into decrypted media data 100. License information 132 comprises time-limit information limiting usage of media data 100. License information 132 may comprise other information, such as copyright regulation.

After generating protected media file 120 and license file 130, server 20 stores protected media file 120 and license file 130 in a memory of server 20.

Server 20 transmits description file 110 to mobile communication device 10 (step S8).

Mobile communication device 10 receives description file 110 from server 20 (step S10). Description file 110 may be represented as a web page, conforming to Extensible Markup Language (XML) or Wireless Markup Language (WML) for example. Mobile communication device 10 can use media drive 11 to decode description file 110 and display the web page thereof which can then be viewed by the user of mobile communication device 10 to determine whether to download protected media file 120 and license file 130.

If the user decides to download protected media file 120, mobile communication device 10 transmits a protected media file download request to server 20 based on the download information 111 of protected media file 120 (step S12). Protected media file 120 is downloaded to mobile communication device 10 in response to the download request. After receiving the protected media file download request (step S14), server 20 transmits protected media file 120 from server 20 to mobile communication device 10 (step S16).

Mobile communication device 10 receives protected media file 120 from server 20 (step S18) and stores protected media file 120 in memory 4.

If the user decides to download license file 130, mobile communication device 10 transmits a license file download request to server 20 based on the download information 112 of license file 130 (step S20). The license file 130 is downloaded from server 20 to mobile communication device 10 in response to the download request. After receiving the license file download request (step S22), server 20 transmits license file 130 to mobile communication device 10 (step S24).

Mobile communication device 10 receives license file 130 from server 20 (step S26) and stores license file 130 in memory 4.

Mobile communication device 10 decodes and decrypts protected media file 120 to acquire the media data 100 using license file 130 (step S28). Specifically, mobile communication device 10 decrypts encrypted data 124 to acquire the media data 100 using decryption key 131. Mobile communication device 10 then opens and displays or plays media data 100 using the media drive 11.

License information 132 sets an expiration date or limits the usage period for media data 100. When decrypting protected media file 120 using license file 130, mobile communication device 10 limits the usage period or expiration date of media data 100 according to license information 132. For example, the limitation of the usage period or the expiration date is recorded in the data structure of media data 100. When playing media data 100, mobile communication device 10 must determine whether the usage period or expiration date is expired and limit the usage of media data accordingly. Under the condition, no usage time limitation of the license file 130 is provided. License file 130 is used only once when decrypting protected media file 120. Mobile communication device 10 enforces the usage period or the expiration date recorded in the data structure to limit the usage of media data 100.

For example, mobile communication device 10 is prevented from storing decrypted media data 100. When opening media data 100, mobile communication device 10 must use the license file 130 to decrypt protected media file 120 and generate media data 100. Usage of license file 130 or protected media file 120 is limited by license information 132. After expiration, mobile communication device 10 no longer outputs license file 130. Thus, media data 100 cannot be copied.

License information 132 may further comprise a usage time limit for limiting the usage of media data 100 to a predetermined number of times.

The data protection method of the invention may further include a fee mechanism. For example, a fee gateway may be located at WAP gateway 15 or server 20, whereby users downloading media data 100 are charged a fee.

Hence, the data protection method of the invention can ameliorate the disadvantages of conventional techniques.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A data protection method, implemented in a server and a mobile communication device capable of wireless communication with the server, comprising the steps of:
the mobile communication device transmitting a media download request to the server for downloading a set of media data;
the server receiving the media download request;
the server generating a description file, a protected media file and a license file in response to the media download request, wherein the description file comprises download information of the protected media file and the license file, the protected media file comprises a set of encrypted data generated from encrypting the media data, and the license file comprises a decryption key for decrypting the encrypted data into media data;
the server transmitting the description file to the mobile communication device; and
the mobile communication device receiving the description file from the server.

2. The method as claimed in claim 1, further comprising the steps of
the mobile communication device transmitting a protected media file download request to the server for downloading the protected media file based on the download information of the protected media file; and
the mobile communication device receiving the protected media file from the server.

3. The method as claimed in claim 2, further comprising the steps of:
the mobile communication device transmitting a license file download request to the server for downloading the protected media file based on the download information of the license file; and
the mobile communication device receiving the license file from the server.

4. The method as claimed in claim 3, further comprising the step of the mobile communication device decrypting the set of encrypted data to acquire the set of media data using the license file.

5. The method as claimed in claim 1, wherein the license file further comprises time-limit information of the set of media data.

6. A data protection method, implemented in a server capable of wireless communication with a mobile communication device, comprising the steps of:
receiving, from the mobile communication device, a media download request for requesting transmission of media data to the mobile communication device;
generating a description file, a protected media file and a license file of media data in response to the media download request, wherein the description file comprises download information of the protected media file and the license file, the protected media file comprises encrypted data generated from encrypting the media data, and the license file comprises a decryption key for decrypting the encrypted data into media data; and
transmitting the description file to the mobile communication device.

7. The method as claimed in claim 6, further comprising the steps of
receiving a protected media file download request from the mobile communication device for transmitting the protected media file to the mobile communication device; and
transmitting the protected media file to the mobile communication device.

8. The method as claimed in claim 7, further comprising the steps of:
receiving a license file download request from the mobile communication device for transmitting the license file to the mobile communication device; and
transmitting the license file to the mobile communication device.

9. A data protection method, implemented in a mobile communication device capable of wireless communication with a server, comprising the steps of:
transmitting a media download request to the server for downloading a set of media data;
receiving a description file from the server, wherein the description file comprises download information of a protected media file and a license file, the protected media file comprises encrypted data generated by the server encrypting the media data, and the license file comprises a decryption key for decrypting the encrypted data into media data;
transmitting a protected media file download request to the server for downloading the protected media file based on the download information of the protected media file;
receiving the protected media file from the server.
transmitting a license file download request to the server for downloading the license file based on the download information of the license file; and
receiving the license file from the server.

10. The method as claimed in claim 9, further comprising the step of decrypting the encrypted data to acquire the media data using the license file.

11. The method as claimed in claim 9, wherein the license file further comprises time-limit information of the set of media data.

12. A data protection system, comprising:
a mobile communication device; and
a server capable of wireless communication with the mobile communication device, wherein the server receives, from the mobile communication device, a media download request for transmission of media data to the mobile communication device, the server generates a description file, a protected media file and a license file of the requested media data in response to the media download request, wherein the description file comprises download information of the protected media file and the license file, the protected media file comprises a set of encrypted data generated from encrypting the media data, and the license file comprises a decryption key for decrypting the set of encrypted data into the set of media data, and the server transmits the description file to the mobile communication device.

13. The system as claimed in claim 12, wherein the server receives a protected media file download request from the mobile communication device for transmitting the protected media file, and the server transmitting the protected media file to the mobile communication device.

14. The system as claimed in claim 13, wherein the server receives a license file download request from the mobile communication device for transmitting the license file, and the server transmits the license file to the mobile communication device.

15. The system as claimed in claim 14, wherein the mobile communication device decrypts the set of encrypted data to acquire the media data using the license file.

16. The system as claimed in claim 12, wherein the license file further comprises time-limit information of the set of media data.
